(19) United States
(12) Patent Application Publication
(10) Pub. No.: US 2019/0132272 A1
(43) Pub. Date: May 2, 2019

(54) GRAPHIC NETWORK COMMUNICATIONS WITH VENDOR AUGMENTED CONTENT

(71) Applicant: INMOJI, INC., San Francisco, CA (US)

(72) Inventor: Michael Africk, San Francisco, CA (US)

(21) Appl. No.: 15/796,904

(22) Filed: Oct. 30, 2017

(51) Int. Cl. H04L 12/58; G06T 19/00; G06Q 30/02; G06F 17/30; H04W 4/02

(52) U.S. Cl. CPC H04L 51/10; G06T 19/006; H04L 51/12; H04W 4/02; G06F 17/30917; H04L 51/38; G06Q 30/02

(57) ABSTRACT

A mobile messaging device and application augments user generated messaging content with prequalified graphic content based on situational parameters and vendor subscribed criteria. An initiating device responsive to a user captures user supplied content, such as video or still images. A selected prequalifier is indicative of augmented content based on a mood, theme, novelty or emotive inclination of the sender. The prequalifier may be an arbitrary, fanciful or themed selection based on an accompanying theme to the user supplied content. Vendor initiated filters denote a match with augmented content to accompany the user selected content based on the prequalifier and the filter. Integration logic on the sender device integrates augmented content of the most relevant vendor with the user supplied content, and the integrated content is transported to the recipient device for rendering thereon.

### BACKGROUND

Electronic messaging and related social media applications (apps) have enjoyed almost exponential growth in recent decades due to widespread availability of mobile communication devices and public access computer networks such as the Internet. Messaging in conjunction with user supplied media, due to the almost synonymous integration of cameras with most mobile devices, have further fueled the growth of social media apps and websites. As a result, many network outlets exist for electronic communication including user captured visual images.

### SUMMARY

A mobile messaging device and application augments user generated messaging content with prequalified graphic content based on situational parameters and vendor subscribed criteria. An initiating device, responsive to a user, captures user supplied content such as video or still images. A selected prequalifier is indicative of augmented content based on a mood, theme, novelty or emotive inclination of the sender. The prequalifier may be an arbitrary, fanciful or themed selection based on an accompanying theme to the user supplied content. Vendor initiated filters denote a match with augmented content to accompany the user selected content based on the prequalifier and the filter. Integration logic on the sender device integrates augmented content of the most relevant vendor with the user supplied content, and the integrated content is transported to the recipient device for rendering thereon.

Configurations herein are based, in part, on the observation that mobile devices facilitate interpersonal messaging by allowing capture and transmission of user generated content in a portable network conversant device. A conventional cellphone, smartphone, tablet or other personal telecommunications device (mobile device) combines image capture and network transmission capability in a portable package that permits spontaneous sharing of user generated content such as pictures (i.e. “selfies” and video). Unfortunately, conventional approaches to inter-device messaging suffer from the shortcoming that fanciful or arbitrary augmentations are difficult to inject into the pictorial image content. Accompanying text may be appended, but the rendered content remains separated. While browser renderings are commonly overlaid or tiled with third party and commercial content, user generated content is typically transmitted in an unaugmented manner. At most, conventional approaches may provide graphical apps to manually modify or “dress up” pictorial captures, which may import a content item, allow edits, and export the content for subsequent inclusion—a time consuming and tedious process.

Accordingly, configurations herein substantially overcome the above-described shortcomings of conventional messaging approaches by providing selections of prequalifiers that denote a genre, topic or type of augmented content for integration with user supplied content. The prequalifier includes integration logic for applying the augmented content to the images in the user supplied content, and is based on a filter that applies different augmented content based on a context of the communication, such as location, time and user demographics. The prequalifiers denote a particular emotive content or enhancement that the sender wishes to convey. For example, a hungry user might select a prequalifier of a pizza slice. The augmented content might include a selfie of the user (sender) with an image of a slice of pizza positioned as if the user were eating it. Vendor supplied content might include a contact number and/or link for a nearby restaurant based on the geolocation of the user matching the filter of the restaurant. The same prequalifier in another location might result in vendor content of a pizza delivery contact of that location.

In further detail, the method of rendering content on a mobile device as disclosed herein includes receiving user content resulting from user gathered media on a mobile device of the user, such that the user content includes visual images, and receiving a selection of a prequalifier indicative of augmented content, in which the prequalifier is stored in a library and the augmented content is adapted for combining with the user supplied content. The mobile device filters the available augmented content based on a profile including demographics, geo-location and characteristics of the mobile device, and augments the user content with the filtered, augmented content by graphical modification to a stored visual image depicting the user content. A server and public access network such as the Internet are invoked to transmit the augmented user content to a mobile device of an intended recipient for rendering, in which the renderable, augmented user content is denoted by the selected prequalifier in an incoming message or email list.

In deployment, configurations herein may take the form of a mobile device for sharing video images, including a video capture element adapted to perform electronic recording of user generated content of visual images, and a database of prequalifiers, such that each prequalifier has a graphical icon and is indicative of augmented content configured for applicability to the recorded visual images. The device further includes a rendering screen for viewing the recorded content and selecting a prequalifier from the database, and a touch based input device for receiving the selection of the prequalifier and recorded content for augmentation. A interface to a network is employed for transmitting the augmented user content to a recipient mobile device adapted for rendering the transmitted content. Prequalifier integration logic configured on the device or an intermediate server is configured for receiving a selection of the prequalifier indicative of augmented content, filtering the augmented content and applying it to the user content.

Still other configurations include a system for capture, modification, transport and rendering of visual messages between mobile devices, defined by a plurality of mobile devices, and a server in communication with the mobile device of a sender, in which the sender mobile device is adapted to visually capture user content. A communication network couples to the server, the mobile device of the sender and a mobile device of a recipient, and a database of prequalifiers denotes each prequalifier by a graphical icon image. Each prequalifier in the database is associated with augmented content adapted to modify a visual image, a vendor subscribing to the prequalifier, and a filter indicative of applicability of the augmented content.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a rendering environment suitable for use with configurations herein;

FIG. 2a-2d show rendered content in the environment of FIG. 1 in accordance with configurations herein;

FIG. 3 is a block diagram of device and server operation for transporting the rendered content of FIGS. 2a-2d; and

FIGS. 4a-4c are a flowchart of augmentation and rendering logic for generating the rendered content of FIG. 3.

### DETAILED DESCRIPTION

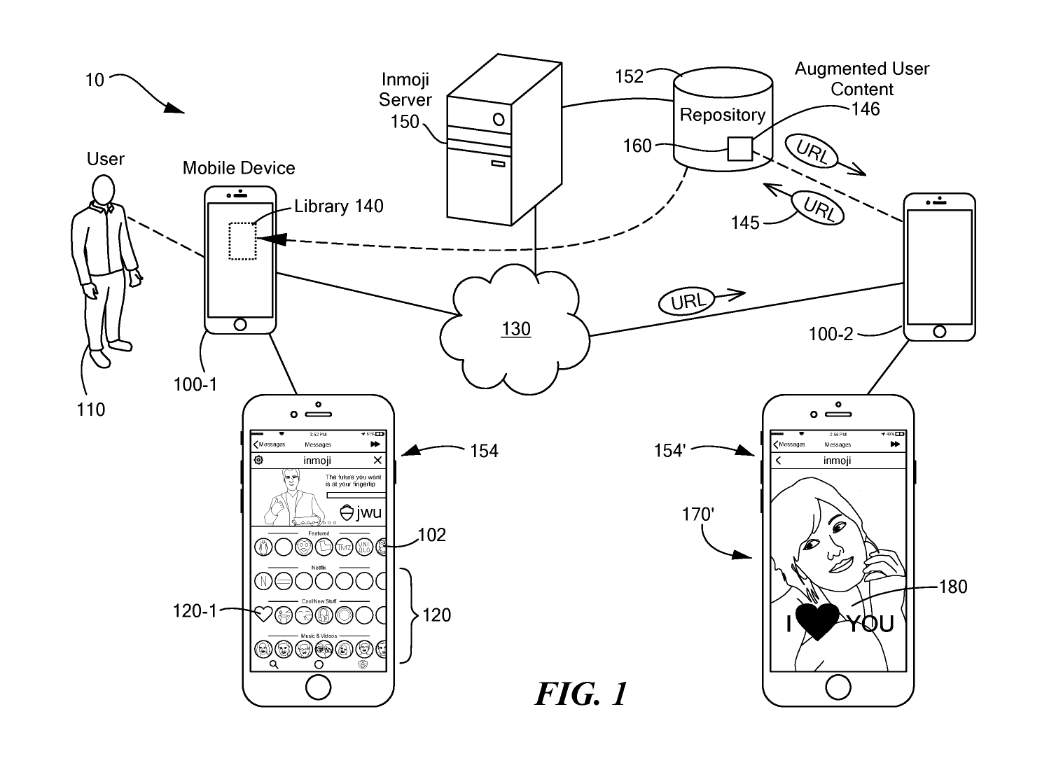

Configurations depicted below present example embodiments of the disclosed approach in the form of a mobile device having an application (app) for implementing the prequalifier selection and resulting augmented content, as now described with reference to FIGS. 1-4c.

It should be emphasized that features of the claimed approach include the ability to “push” user content at the request of the sender, in conjunction with the emotive impression conveyed by the augmented content selected by the sender. A variety of prequalifiers are available at the sender device, for example a pizza slice may denote “I'm hungry.” A sports symbol, such as a baseball or football, may indicate enthusiasm about an upcoming game. Both the prequalifier and the user supplied content are based on a selection received at the sending device, in contrast to conventional approaches which remove sender control over modification to the sent image. The various prequalifiers available via the library are also available for promotional content to be added in conjunction with the emotive content. For example, a banner ad of a local establishment may accompany the pizza slice augmented image. An offer for tickets may accompany a sports based prequalifier, or the user content may place the image of the user with a background as if seated in the sports venue, in addition to an offer or banner for tickets. The actual manner of incorporating the augmented content and applying it to the user content, and further for adding in the promotional content, is determined by the filters associated with the various prequalifiers and prequalifier integration logic. The integration logic interprets and applies the filters based on external factors such as device preferences, location and browsing history, demographics, etc.

In contrast to conventional approaches, the augmented content is identified by graphical prequalifiers that denote the augmented content, such as a pizza slice, baseball or football. Conventional graphic depictions are colloquially known as “emojis,” but appear as a static replacement of a text character and carry no further significance or action. Further, these prequalifiers are offered to commercial vendors to tap into users whom the prequalifier appeals to. Conventional apps merely parse text entries of queries and messages for terms deemed to present a vendor opportunity. This so-called “adword” approach attaches only to text entries, and has no graphic appeal or content component.

For example, conventional approaches to capturing user content attach merely to the camera app, irrespective of any context. In other words, vendor brands basically just pay to be “inside” the camera when a user invokes, or clicks, on their camera. There is no context. Vendor brands are merely paying to be there when someone opens the camera. In contrast, in configurations herein, the prequalifier icon represents either an emotion that brands buy into or a prequalifying image (generic pizza slice) that the vendor selects to trigger their content for presentation to an end user. It is a “hot” lead because the user has already assented to some appealing aspect of the vendor, not a “cold” lead from merely flashing a banner upon app invocation.

Even absent any promotional content, the value of the graphic prequalifier is apparent in that users are emotionally persuaded by the prequalifier iconic image as the reason for initiating the communication. Further, the prequalifier image is the identifying designator in the receiver's message stream, in lieu of a conventional dot or application icon to denote incoming items. This gives the sender the ability to “hide” what is inside of the communication but still express the idea of what made them take that photo and share it.—in other words, the prequalifier image denotes the “meeting of the minds” between sender and receiver.

Recipient users may be located by any suitable identifier, such as email or social media labels. They need not have the corresponding app installed. Upon receipt of augmented user content, the recipient device 100-2 determines if the recipient device is operable to launch an app responsive to the augmented user content, and if not, launches a browser app responsive to the token (URL). The URL indicative of the content is invoked to render augmented user content.

FIG. 1 is a context diagram of a rendering environment suitable for use with configurations herein. Referring to FIG. 1, in a mobile device environment 10, users employ mobile devices 100-1 . . . 100-2 (100 generally) for communication such as voice, messaging, and content. As is known in the art, multiple options for interpersonal communication is provided by applications (apps) installed on the respective devices 100, often assisted by a social media network or platform. In the examples herein, a sender device 100-1 is under control of an initiating user 110 and a recipient device 100-2 renders messaged content to a recipient user. Users may generally employ a public access network 130 such as the Internet for transmission to mobile devices 100 of other users.

In configurations herein, in contrast to conventional approaches, the sender device 100-1 is directed by the user 110 to supplement user generated media content with augmented content based on a prequalifier selected by the user 110. The augmented content is based on a genre, type or brand indicated by the prequalifier, and optionally with vendor supplied content associated with the prequalifier. In contrast to conventional approaches, the user generated content is graphically (visually) integrated with the augmented content at the sender device 100-1, rather than appended or gathered during transmission, outside the control of the user 110, discussed in further detail below.

A visual display 102 on the sender device 100-1 displays an array of available prequalifiers 120. The prequalifiers 120 define various genres, types and brands, and may be generic or sponsored by vendors. Generally, the prequalifiers are selected to convey emotive or fanciful additions to the user generated content, such as a photo or video. The prequalifiers 120 reside in a local library 140 on the device 100-1, and are cached or downloaded from a server 150. The server 150 also originates app placement on the devices 100-N for supporting a GUI (graphical user interface) and app 154 driving the messaging interface. The server 150 maintains a repository 152 for storing the full library table 162 of prequalifiers and associated information, discussed further below. Individual devices 100 are periodically updated from the repository 152.

In operation, the originating device 100-1 is invoked for capturing user generated content, such as a still or a short video. A selected prequalifier 120-1 and corresponding user generated content are sent to the recipient device 100-2 as a URL (uniform resource locator) referencing a location in the server repository 152. Upon receipt, the recipient device 100-2 receives an input directing rendering of the URL 145, and the renderable content 146 including the augmented content integrated with the user generated content is sent to the device 100-2. The resulting augmented user content 180 is viewable on the display 170′ by the app 154′.

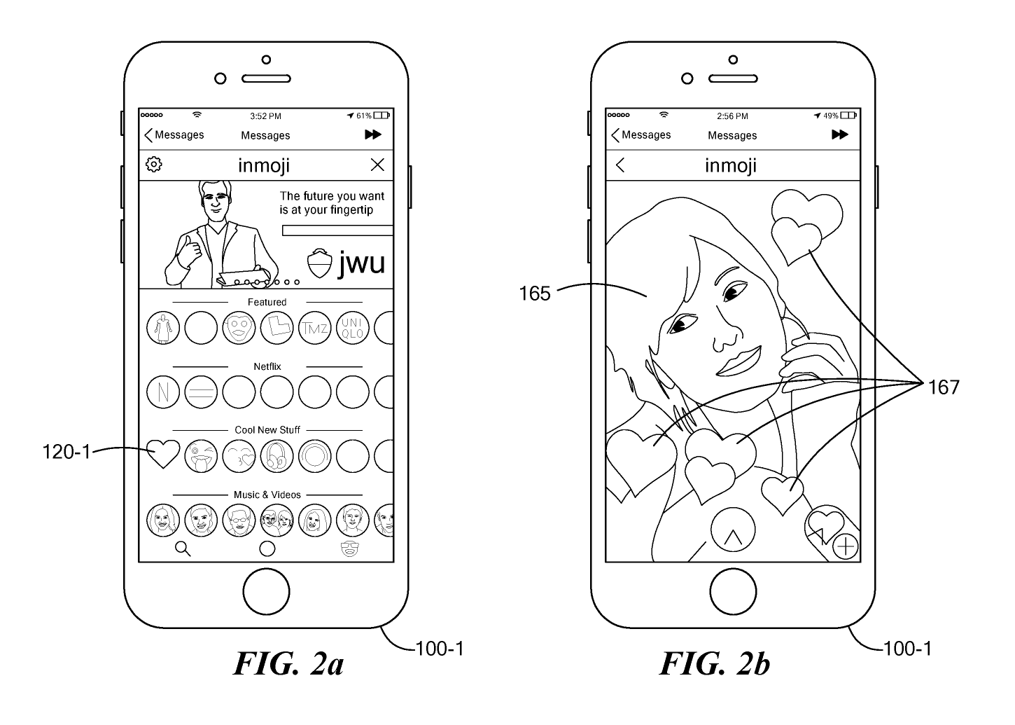

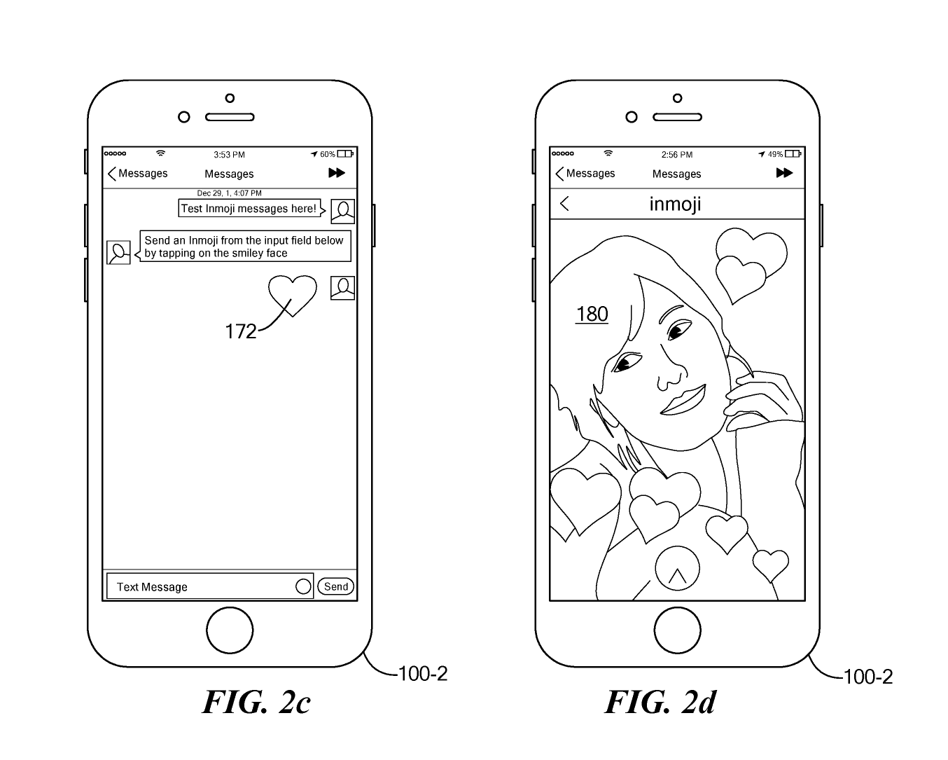

FIGS. 2a-2d show rendered content in the environment of FIG. 1 in accordance with configurations herein. Referring to FIGS. 1 and 2a-2d, in an example configuration, the mobile device 100-1 has a selection of available prequalifiers 120 depicted as icons on the visual display of the device 100-1. The device 100-1 receives a selection of a prequalifier 120-1, and in FIG. 2b, a camera on the user device 100-1 opens for receiving the user content 165, typically a picture or video. Augmented content 167 based on the prequalifer 120-1 appears integrated with the user content 165, in an overlay or interspersed manner based on prequalifier integration logic. In FIG. 2c, a recipient user receives an icon 172 indicative of the prequalifier 120-1 on the recipient device 100-2. Typically, the application 154′ renders this as a text message or similar communication indicative of the augmented user content 180. The device 100-2 receives a click or selection of the icon 172 for rendering the augmented user content 180 on the device 100-2.

Upon receiving the augmented user content 180, the content may persist for only a predetermined amount of time. The received augmented user content 180 may be time sensitive based on users setting an expiration timer before they send it to friend/recipient. The distinction here is that unlike conventional apps, if a click is on the content is not received in time, the content is purged. For example, if a user sets the timer to 20 seconds and the recipient does not open your phone and look at it within the 20 seconds, it may be gone.

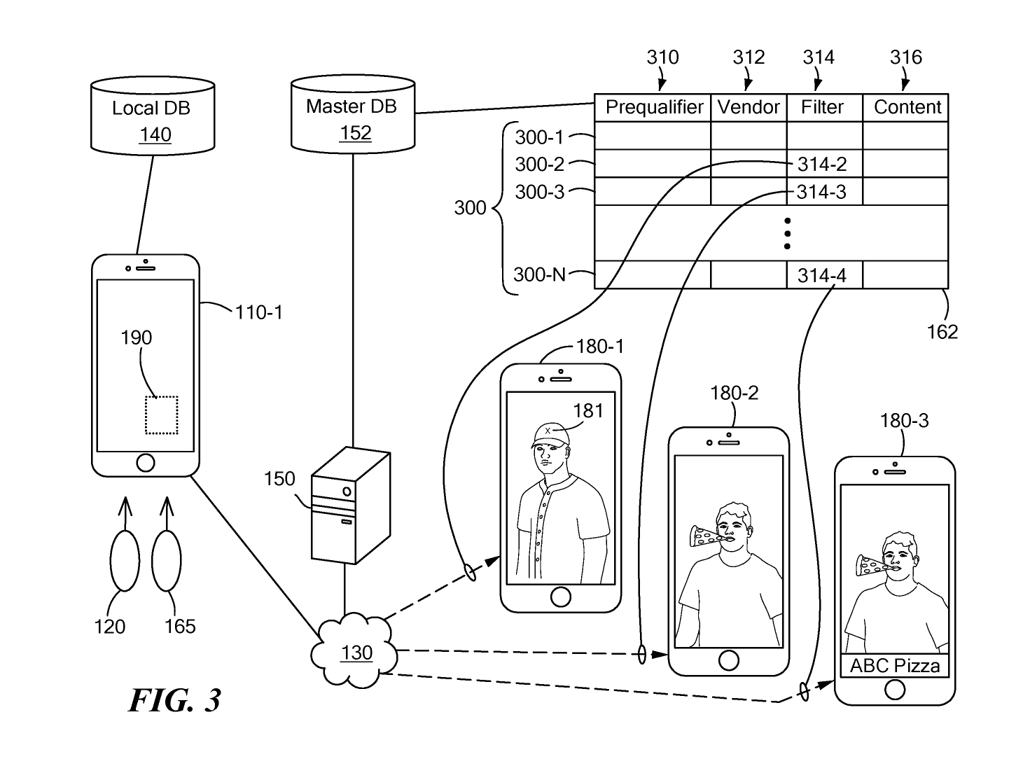

FIG. 3 is a block diagram of device and server operation for transporting the rendered content of FIG. 2a-d. Referring to FIGS. 1 and 3, FIG. 3 shows a flow of the data entities involved in rendering the augmented user content 180. Augmented content includes emotive, arbitrary or fanciful graphic features (emotive content), and promotional content based on vendors who subscribe to particular prequalifiers based on a correlation to their products and/or services. The server 150 invokes the repository 152 for storing and referencing the prequalifiers along with associated vendors and filters. In some cases, prequalifiers may be associated with only emotive content for overlay integration with the user content. Other prequalifiers may have one or more vendors and associated promotional content listed in the repository 152. Each vendor and subscribed prequalifier has a filter indicating when to apply the promotional content. For example, some vendors may only be relevant to certain geographic regions, and the filter would indicate to apply that promotional content only to prequalifiers selected in that region. Other vendors may subscribe to the same prequalifier for other geographic regions. Prequalifier integration logic 190 interprets the filters and determines which content to apply. The attributes of the filter may include aspects such as geolocation, commercial entities in the browsing history, queries stored in the browsing history, and recent purchases denoted in the browsing history.

In FIG. 3, the mobile device 100-1 receives the selected prequalifier 120 and user content 165. Prequalifier integration logic 190 (discussed further below), included in the app 154, employs filters associated with the prequalifier to identify the emotive and promotional content to apply and the graphical positioning and overlay content to impose on the user content 165.

The network repository 152 may further define a database including a mapping from each prequalifier to promotional content. The repository 152, in the example configuration, stores the library of prequalifiers 120 as a table 162. The table includes entries 300-1 . . . 300-N (300 generally), each having a prequalifier 310, a vendor 312, a filter 314 and content 316 in respective columns. The prequalifier column 310 indicates the rendered prequalifier 120 selectable on the device 100-1, and may have more than one entry if multiple vendors subscribe to it. The vendor column 312 indicates the subscribing vendor. If no vendor has subscribed, the prequalifier 310 is indicative of only emotive content. The filter column 314 identifies the filter associated with the prequalifier for the vendor, and includes attributes such as geolocation, timing and demographics. Vendors may decide to focus their promotional content to particular regions, at particular times, or for certain demographics, such as age or gender, depending on the customer base of the vendor. For example, pizza content may be applied only during afternoon or evening hours, or concert tickets that are directed only to teens and young adults. The content column 316 indicates the augmented content to apply, and includes either the vendor promotional content or simply emotive content if no vendor has subscribed. The content 316 may be stored by reference to graphical features, rather than as a table; storage depictions are logically shown.

The prequalification integration logic 190 determines, based on the entries 300 for a particular prequalifier 120, which content to apply based on the filters. For example, a baseball prequalifier, corresponding to filter 314-2 from entry 300-2, may result in augmented user content 180-1 of user image with a cap and jersey having insignia 181 for “Yankees” ® or “Red Sox”® depending on whether the mobile device 100-1 is in New York or Boston. Similarly, a pizza slice prequalifier 120, corresponding to filters 314-3 and 314-4 may result in either a user image with a pizza slice imposed as if the picture subject were eating it (content 180-2), or with a banner from a local pizza establishment, shown as augmented user content 180-3.

Implementation of the filters for determining the augmented content may be done in any suitable manner. Depending on the number of prequalifiers, the filters may be stored or cached on a local database (library 140) on the mobile device, in which the local database is periodically refreshed. Multiple filters may exist for each prequalifier, depending on the vendor distribution, as the filter indicative of the promotional content corresponding to the filter.

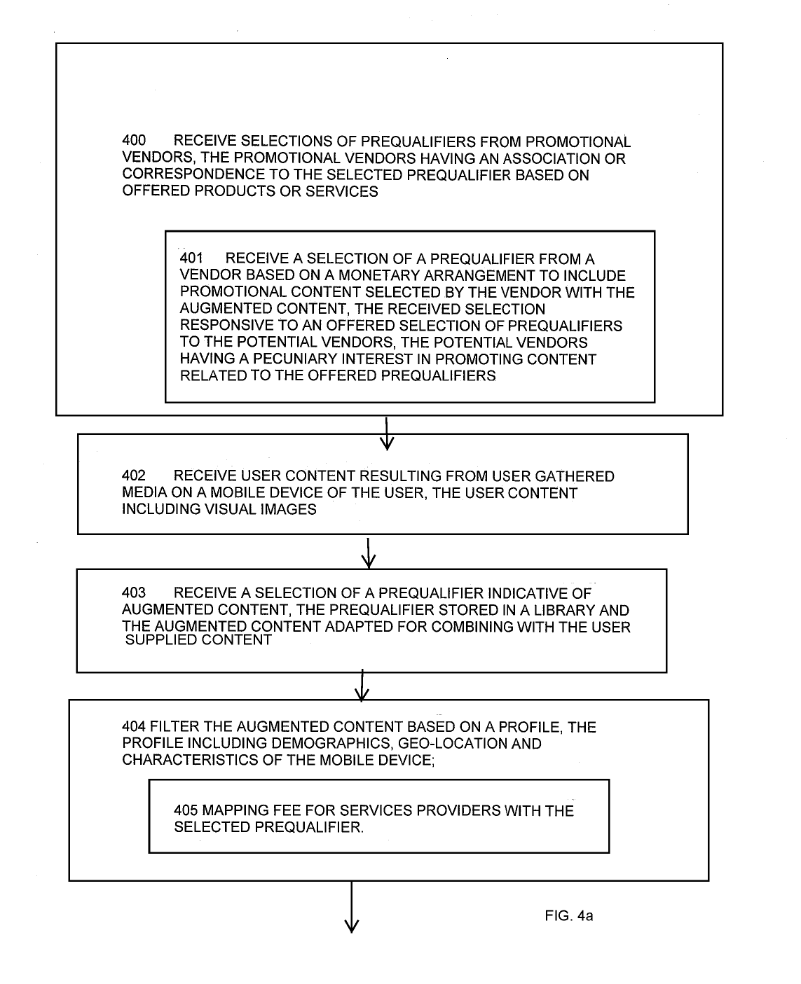

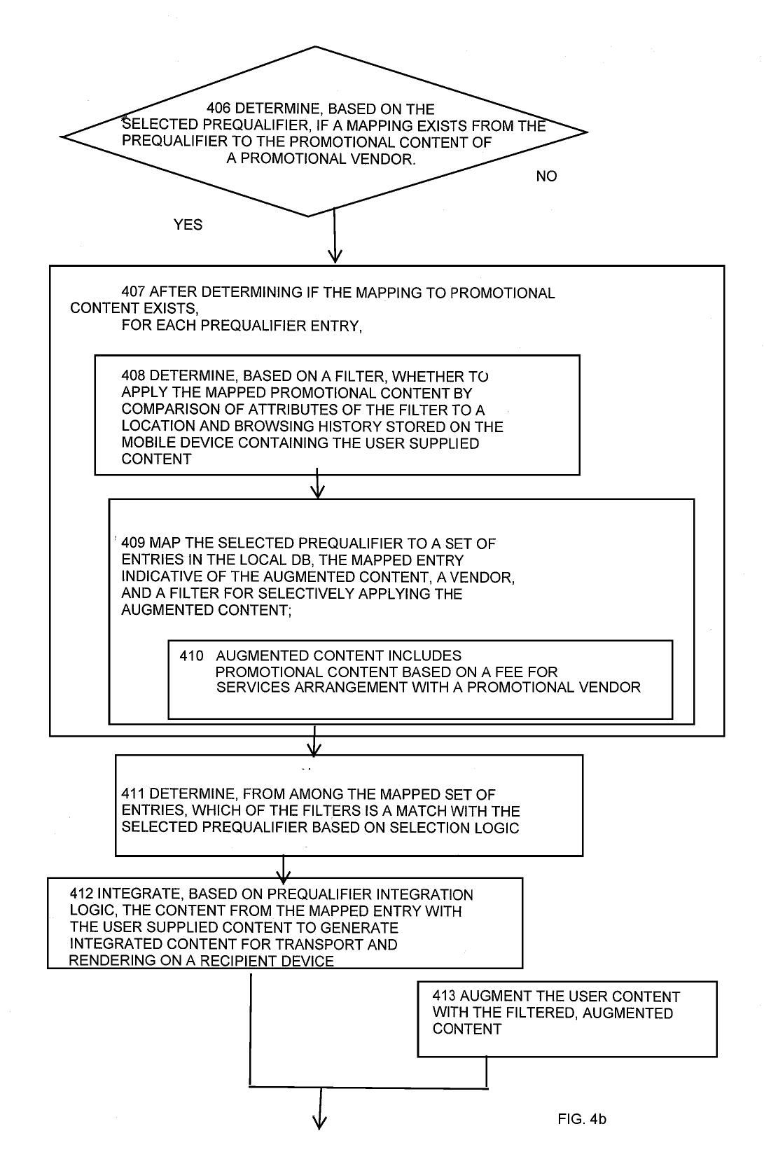

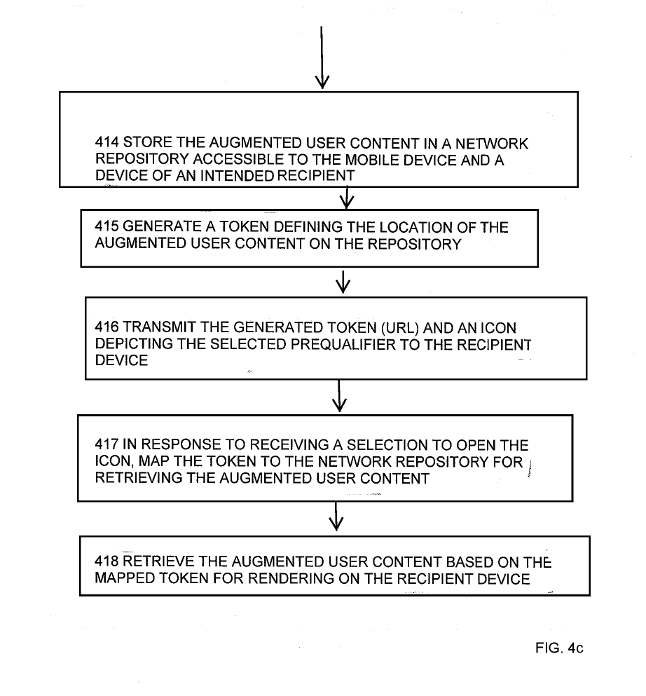

FIG. 4a-4c are a flowchart of a system for administrating, disseminating and deploying the augmentation and rendering logic for generating the rendered content of FIG. 3. Referring to FIGS. 3 and 4a-c, at step 400, the server 150 receives selections of prequalifiers 120 from promotional vendors, in which the promotional vendors have an association or correspondence to the selected prequalifier based on offered products or services. For example, the pizza prequalifier may be found appealing to a pizza or sub shop. Sporting equipment (i.e. baseballs, footballs) may be found appealing to various professional sporting teams. Vendors may even promote their own logo as a prequalifier. In particular configurations, generally, the server 150 receives a selection of a prequalifier from a vendor based on a monetary arrangement to include promotional content selected by the vendor with the augmented content, as depicted at step 401. The received selection of the vendor is responsive to an offered selection of prequalifiers to the potential vendors, where the vendors have a pecuniary interest in promoting content related to the offered prequalifiers. Vendors therefore seek prequalifiers tending to bear a suggestion toward their products or services, or may prefer to list their own logo or emblem as a prequalifier 120.

Upon application launch, the mobile device 100-1 receives user content 165 resulting from user gathered media on the mobile device 100-1 of the user such that the user content includes visual images (stills or video), as shown at step 402. The user also selects a prequalifier 120 indicative of augmented content, as shown at step 403, such that the prequalifier is stored in a library 140 and the augmented content is adapted for combining with the user supplied content. The mobile device 100-1 receives the selection and now has both a prequalifier and user content.

Prequalifier integration logic 190 filters the augmented content based on a profile including demographics, geo-location and characteristics of the mobile device, as depicted at step 404. In particular configurations, filtering the augmented content further includes mapping fee for services providers with the selected prequalifier, as shown at step 405. The prequalifier integration logic 190 identifies which augmented content to apply based on the filters. This includes a check for determining, based on the selected prequalifier, if a mapping exists from the prequalifier to the promotional content of a promotional vendor, as depicted at step 406.

If, at step 406, there is at least one entry for promotional content, that is, at least one vendor has subscribed to the prequalifier, then the prequalifier integration logic 190 determines which filter applies, as shown at step 407. After determining if the mapping to promotional content exists, for each prequalifier entry, the prequalifier integration logic 190 determines, based on the corresponding filter, whether to apply the mapped promotional content by comparison of attributes of the filter to a location and browsing history stored on the mobile device 100 containing the user supplied content 165, as shown at step 408. This includes mapping the selected prequalifier to a set of entries in the local DB, in which the mapped entry indicative of the augmented content, a vendor, and a filter for selectively applying the augmented content, as disclosed at step 409. In other words, whichever filter 314 has attributes that most closely aligns with the device denote the augmented contact to integrate. As indicated above, the augmented content generally includes promotional content based on a fee for services arrangement with the promotional vendor subscribing or contracting for the prequalifier 120, as depicted at step 410. At step 411, the prequalifier integration logic 190 includes selection logic that determines, from among the mapped set of entries 300, which of the filters is a match with the selected prequalifier based on the selection logic.

The selected augmented content 316 is then integrated, based on the prequalifier integration logic 190, the content from the mapped entry 300 with the user supplied content to generate integrated content for transport and rendering on the recipient device 100-2, as disclosed at step 412. Otherwise, if the check at step 406 indicates that no promotional content is associated with the prequalifier, then the user content 165 is integrated with the augmented content 167, as depicted at step 413. In either case, the prequalifier integration logic 190 overlays the augmented content on the user supplied content to generate augmented user content 180 with an emotive component corresponding to the prequalifier 120.

The augmented user content may be transported and rendered via the recipient mobile device 100-2 by any suitable manner. In a particular configuration, the server 150 stores the augmented user content 146 in the network repository 152 accessible to the mobile device 100-1 and a device 100-2 of the intended recipient, as shown at step 414. The initiating (sending) mobile device 100-1 sends the augmented user content 146 to the server 150. The server 150 generates a token, such as a URL (Uniform Resource Locator) defining the location of the augmented user content on the repository 152, as shown at step 415. The network 130 is used for transmitting the generated token (URL) and an icon depicting the selected prequalifier to the recipient device 100-2, as depicted at step 416. In response to receiving a selection to open the icon, the recipient mobile device 100-2 maps the token (URL) to the network repository 152 for retrieving the augmented user content, as shown at step 417. The mobile device 100-2 retrieves the augmented user content 145 based on the mapped token for rendering on the recipient device. The augmented user content 145 visually depicts the user content with the augmented content graphically applied in a meaningful format applicable to both the emotive value and commercial value intended to be conveyed by the augmented content. The resulting augmented user content 180 is then rendered on the recipient device 100-2.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method of rendering content on a mobile device, comprising:
receiving user content resulting from user gathered media on a mobile device of the user, the user content including visual images;
receiving a selection of a prequalifier indicative of augmented content, the prequalifier stored in a library and the augmented content adapted for combining with the user supplied content;
filtering the augmented content based on a profile, the profile including demographics, geo-location and characteristics of the mobile device;
augmenting the user content with the filtered, augmented content by graphical modification to a stored visual image depicting the user content; and
transmitting the augmented user content to a mobile device of an intended recipient for rendering, the renderable, augmented user content denoted by the selected prequalifier.

2. The method of claim 1 wherein transmitting the augmented user content further comprises:
storing the augmented user content in a network repository accessible to the mobile device and the mobile device of an intended recipient;
generating a token defining the location of the augmented user content on the repository;
transmitting the generated token (URL) and an icon depicting the selected prequalifier to the recipient device;
in response to receiving a selection to open the icon, mapping the token to the network repository for retrieving the augmented user content; and
retrieving the augmented user content based on the mapped token for rendering on the recipient device.

3. The method of claim 1 wherein the augmented content includes promotional content based on a fee for services arrangement with a promotional vendor.

4. The method of claim 2 further comprising determining if the recipient device is operable to launch an app responsive to the augmented user content, and if not, launching a browser app responsive to the token (URL).

5. The method of claim 1 wherein filtering the augmented content further includes mapping fee for services providers with the selected prequalifier.

6. The method of claim 5 further comprising receiving selections of prequalifiers from promotional vendors, the promotional vendors having an association or correspondence to the selected prequalifier based on offered products or services.

7. The method of claim 5 further comprising:
receiving a selection of a prequalifier from a vendor based on a monetary arrangement to include promotional content selected by the vendor with the augmented content, the received selection responsive to an offered selection of prequalifiers to the potential vendors, the potential vendors having a pecuniary interest in promoting content related to the offered prequalifiers.

8. The method of claim 3 further comprising determining, based on the selected prequalifier, if a mapping exists from the prequalifier to the promotional content of a promotional vendor.

9. The method of claim 3 wherein the network repository further comprises a database including a mapping from each prequalifier to promotional content.

10. The method of claim 8 further comprising, after determining if the mapping to promotional content exists,
determining, based on a filter, whether to apply the mapped promotional content by comparison of attributes of the filter to a location and browsing history stored on the mobile device containing the user supplied content.

11. The method of claim 10 wherein the attributes of the filter include geolocation, commercial entities in the browsing history, queries stored in the browsing history, and recent purchases denoted in the browsing history.

12. The method of claim 3 wherein the prequalifier and the user supplied content are based on a selection received at the sending device.

13. The method of claim 2 further comprising:
storing the filter on a local database (DB) on the mobile device, the local database periodically refreshed, the filter indicative of the promotional content corresponding to the filter.

14. The method of claim 13 further comprising:
mapping the selected prequalifier to a set of entries in the local DB, the mapped entry indicative of the augmented content, a vendor, and a filter for selectively applying the augmented content;
determining, from among the mapped set of entries, which of the filters is a match with the selected prequalifier based on selection logic;
integrating, based on prequalifier integration logic, the content from the mapped entry with the user supplied content to generate integrated content for transport and rendering on a recipient device.

15. In a communications network having wirelessly communicative mobile devices, a mobile device for sharing video images, comprising:
a video capture element adapted to perform electronic recording of user generated content of visual images;
a database of prequalifiers, each prequalifier having a graphical icon and indicative of augmented content configured for applicability to the recorded visual images;
a rendering screen for viewing the recorded content and selecting a prequalifier from the database;
a touch based input device for receiving the selection of the prequalifier and recorded content for augmentation;
an interface to a network for transmitting the augmented user content to a recipient mobile device adapted for rendering the transmitted content; and
prequalifier integration logic configured for:
receiving a selection of a prequalifier indicative of augmented content, the prequalifier stored in a library and the augmented content adapted for combining with the user supplied content;
filtering the augmented content based on a profile, the profile including demographics, geo-location and characteristics of the mobile device; and
augmenting the user content with the filtered, augmented content by graphical modification to a stored visual image depicting the user content.

16. The device of claim 15 method of claim 1 wherein filtering the augmented content further includes mapping fee for services providers with the selected prequalifier.

17. The method of claim 16 further comprising an interface to a server for receiving selections of prequalifiers from promotional vendors, the promotional vendors having an association or correspondence to the selected prequalifier based on offered products or services.

18. The device of claim 17 further comprising:
a local database on the mobile device responsive to mapping the selected prequalifier to a set of entries in the local DB, the mapped entry indicative of the augmented content, a vendor, and a filter for selectively applying the augmented content,
the prequalifier integration logic further configured for
determining, from among the mapped set of entries, which of the filters is a match with the selected prequalifier based on selection logic; and
integrating, based on prequalifier integration logic, the content from the mapped entry with the user supplied content to generate integrated content for transport and rendering on a recipient device.

19. A system for capture, modification, transport and rendering of visual messages between mobile devices, comprising:
a plurality of mobile devices;
a server in communication with the mobile device of a sender, the sender mobile device adapted to visually capture user content;
a communication network coupled to the server, the mobile device of the sender and a mobile device of a recipient; and
a database of prequalifiers denoted by a graphical icon image, each prequalifier associated with augmented content adapted to modify a visual image, a vendor subscribing to the prequalifier, and a filter indicative of applicability of the augmented content;
the mobile device having prequalifier integration logic configured for:
receiving a selection of a prequalifier indicative of augmented content, the prequalifier stored in a library and the augmented content adapted for combining with the user content;
applying the corresponding filter to the augmented content based on a profile, the profile including demographics, geo-location and characteristics of the mobile device; and
augmenting the user content with the filtered, augmented content by graphical modification to a stored visual image depicting the user content;
the mobile devices having an interface to the network for transmitting the augmented user content.

20. A computer program product on a non-transitory computer readable storage medium having instructions that, when executed by a processor, perform a method for rendering content on a mobile device, the method comprising:
receiving user content resulting from user gathered media on a mobile device of the user, the user content including visual images;
receiving a selection of a prequalifier indicative of augmented content, the prequalifier stored in a library and the augmented content adapted for combining with the user supplied content;
filtering the augmented content based on a profile, the profile including demographics, geo-location and characteristics of the mobile device;
augmenting the user content with the filtered, augmented content by graphical modification to a stored visual image depicting the user content; and
transmitting the augmented user content to a mobile device of an intended recipient for rendering, the renderable, augmented user content denoted by the selected prequalifier.

21. The method of claim 1 further comprising:
receiving an expiration time in conjunction with the user content; and
directing the augmented user content to be deleted following an interval based on the expiration time if the recipient device does not receive a request for rendering.
